(19) United States
(12) Patent Application Publication
(10) Pub. No.: US 2025/0010478 A1
(43) Pub. Date: Jan. 9, 2025

(54) Self-Propelled Robot and Method of Manufacturing Structure

(71) Applicant: Mitsubishi Electric Corporation, Chiyoda-ku, Tokyo (JP)

(72) Inventor: Tomohiro TSUTSUI, Chiyoda-ku, Tokyo (JP)

(73) Assignee: Mitsubishi Electric Corporation, Chiyoda-ku, Tokyo (JP)

(21) Appl. No.: 18/706,333

(22) PCT Filed: Nov. 28, 2022
(86) PCT No.: PCT/JP2022/043819

§ 371 Date: Apr. 30, 2024

(30) Foreign Application Priority Data
Dec. 2, 2021 (JP) 2021-196306

(51) Int. Cl. B25J 9/16; B25J 5/00

(52) U.S. Cl. CPC B25J 9/1694; B25J 5/00

(57) ABSTRACT

A self-propelled robot and a method of manufacturing a structure are provided that enable stable operations of a mobile module and a work module. A self-propelled robot is a self-propelled robot for performing work on a structure. The self-propelled robot includes a mobile module and a work module. The mobile module includes a controller. The mobile module is configured to move relative to the structure. The work module is configured to perform work on the structure. The work module is configured to be detachable from the mobile module. The controller is configured to control movement of the mobile module and work of the work module based on a motion characteristic of the work module.

### TECHNICAL FIELD

The present disclosure relates to a self-propelled robot and a method of manufacturing a structure.

### BACKGROUND ART

Spacecraft components such as solar panels, structure panels, and antennas for satellites have a large size. The manufacture of the spacecraft components requires high accuracy. Also, the manufacture of spacecraft components involves many work processes such as assembly and inspection. It is thus important to reduce the labor cost of each process by automation of the work process using an automation device. Since the production volume of spacecraft components is small, different functions need to be exhibited by one automated device in order to maximize the effects of a labor cost reduction on investments for introducing the automated device. For example, the accuracy required for work by the automated device is less than or equal to 0.1 mm in some cases, and in other cases, the automated device performs cleaning while moving in a wide area.

As the automated device with different functions, for example, Japanese Patent Laying-Open No. 2007-68972 (PTL 1) discloses a mobile robot system. The mobile robot system disclosed in the above publication exhibits a different function for each work module by switching a work module connected to a mobile robot (mobile module) of a plurality of work modules. The plurality of work modules are attached to and detached from the mobile robot (mobile module) via a module station.

### CITATION LIST

### Patent Literature

PTL 1: Japanese Patent Laying-Open No. 2007-68972

### SUMMARY OF INVENTION

### Technical Problem

In the mobile robot system disclosed in the above publication, the plurality of work modules have different motion characteristics. Examples of the motion characteristics include the dimensions, weight, and position of the center of gravity of the work module. Upon switch of a work module connected to the mobile robot (mobile module), the motion characteristics of the work module connected to the mobile robot (mobile module) are switched as well. Thus, the motion characteristics of the work module which act on the mobile robot (mobile module) are not constant. This leads to unstable operations of the mobile robot (mobile module) and the work module.

The present disclosure has been made in view of the above problem. An object of the present disclosure is to provide a self-propelled robot and a method of manufacturing a structure that enable stable operations of a mobile module and a work module.

### Solution to Problem

A self-propelled robot of the present disclosure is a self-propelled robot for performing work on a structure. The self-propelled robot includes a mobile module and a work module. The mobile module includes a controller. The mobile module is configured to move relative to the structure. The work module is configured to perform work on the structure. The work module is configured to be detachable from the mobile module. The controller is configured to control movement of the mobile module and work of the work module based on a motion characteristic of the work module.

### Advantageous Effects of Invention

In the self-propelled robot according to the present disclosure, the controller is configured to control movement of the mobile module and work of the work module based on the motion characteristic of the work module. Thus, when the motion characteristic of the work module connected to the mobile module changes upon switch of the work module connected to the mobile module, movement of the mobile module and work of the work module are controlled based on the motion characteristic that has changed. This enables stable operations of the mobile module and the work module.

### BRIEF DESCRIPTION OF DRAWINGS

FIG. 1 is a perspective view schematically showing configurations of a self-propelled robot and a structure according to Embodiment 1.

FIG. 2 is a perspective view schematically showing a configuration of the self-propelled robot according to Embodiment 1.

FIG. 3 is an exploded perspective view schematically showing a configuration of the self-propelled robot according to Embodiment 1.

FIG. 4 is a side view schematically showing a configuration of the self-propelled robot according to Embodiment 1.

FIG. 5 is a functional block diagram schematically showing a configuration of the self-propelled robot according to Embodiment 1.

FIG. 6 is a flowchart schematically showing a method of controlling a self-propelled robot according to Embodiment 1.

FIG. 7 is a flowchart schematically showing a method of manufacturing a structure according to Embodiment 1.

FIG. 8 is a side view schematically showing the self-propelled robot according to Embodiment 1 which has moved below the structure.

FIG. 9 is a side view schematically showing the self-propelled robot according to Embodiment 1 which stands on its own below the structure.

FIG. 10 is a side view schematically showing the self-propelled robot according to Embodiment 1 which has recognized a structure below the structure.

FIG. 11 is a side view schematically showing the self-propelled robot according to Embodiment 1 which is working below the structure.

FIG. 12 is a perspective view schematically showing configurations of a self-propelled robot and a structure according to a modification of Embodiment 1.

FIG. 13 is a side view schematically showing configurations of a self-propelled robot and a structure according to Embodiment 2.

FIG. 14 is a perspective view schematically showing a configuration of a self-propelled robot according to Embodiment 3.

FIG. 15 is a perspective view schematically showing configurations of a self-propelled robot, a frame portion, and a structure according to Embodiment 4.

FIG. 16 is a perspective view schematically showing configurations of a self-propelled robot, a frame portion, and a structure according to Embodiment 5.

FIG. 17 is a partially enlarged perspective view of an area XVII shown in FIG. 16.

FIG. 18 is a perspective view schematically showing configurations of a self-propelled robot, a frame portion, and a structure according to a modification of Embodiment 5.

FIG. 19 is another perspective view schematically showing configurations of the self-propelled robot, the frame portion, and the structure according to the modification of Embodiment 5.

### DESCRIPTION OF EMBODIMENTS

Embodiments will be described below with reference to the drawings. In the description below, the same or corresponding portions are denoted by the same reference characters, and redundant description will not be repeated.

### Embodiment 1

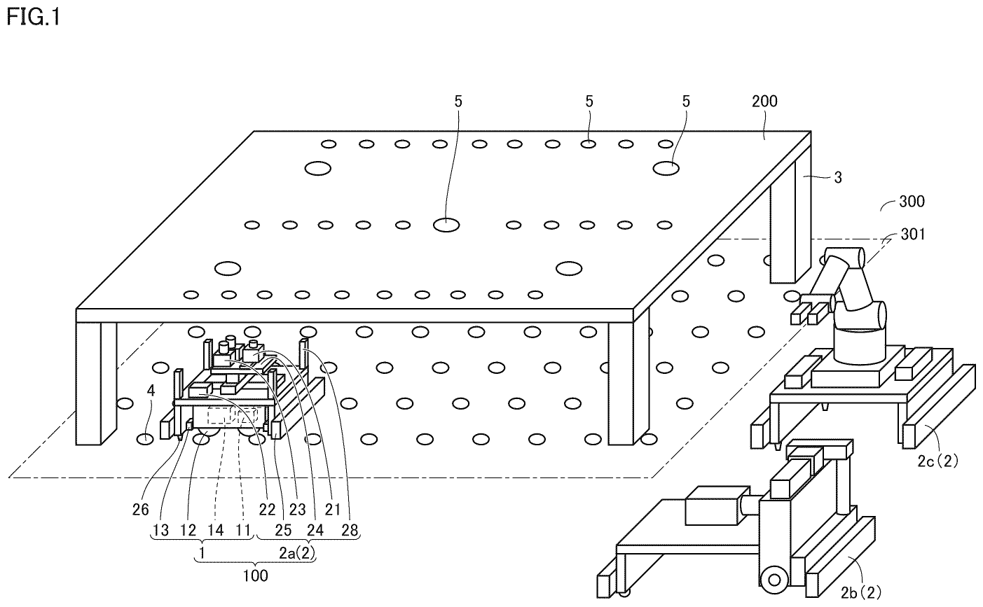

A configuration of a self-propelled robot 100 according to Embodiment 1 will be described with reference to FIGS. 1 to 4.

As shown in FIG. 1, self-propelled robot 100 is a self-propelled robot 100 for performing work on a structure 200. Self-propelled robot 100 is configured to be self-propelled. Self-propelled robot 100 is a self-propelled robot 100 for manufacturing structure 200. Self-propelled robot 100 is a self-propelled robot 100 for assembling structure 200. Self-propelled robot 100 is a self-propelled robot 100 for inspecting structure 200. Self-propelled robot 100 is smaller in overall dimensions than structure 200. Self-propelled robot 100 incudes a mobile module 1 and a work module 2.

Mobile module 1 is configured to move relative to structure 200. Mobile module 1 is configured to be self-propelled. Mobile module 1 is configured to be self-propelled on a floor 300. Structure 200 is supported by a support 3 on floor 300.

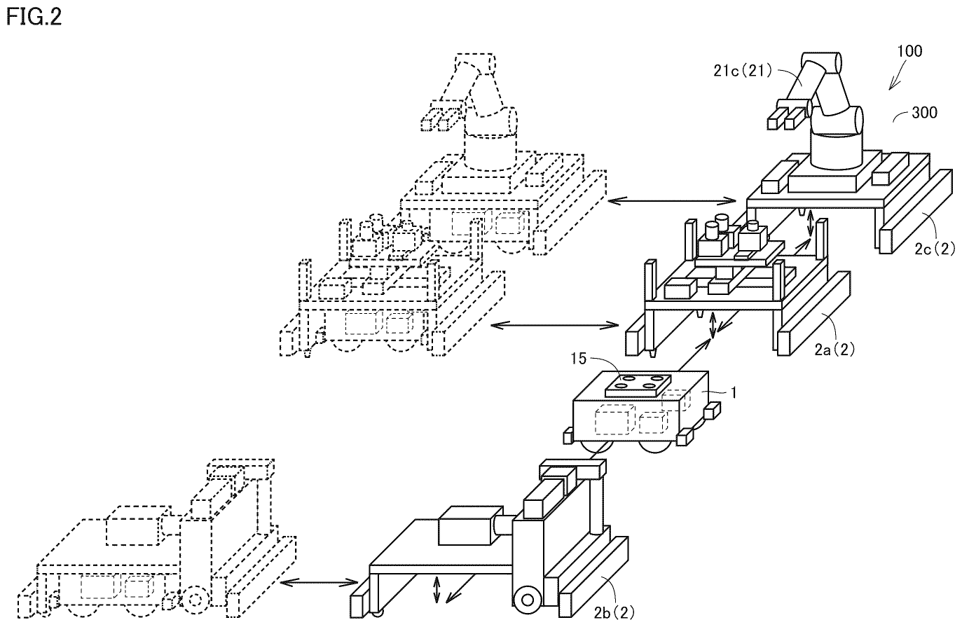

Mobile module 1 mainly includes a controller 11. Mobile module 1 according to the present embodiment further includes a self-propelling portion 12, a floor sensor 13, a battery 14, and a first port 15 (see FIG. 2).

Controller 11 is configured to control movement of mobile module 1 and work of work module 2. As will be described later in detail, controller 11 is configured to control movement of mobile module 1 and work of work module 2 based on a motion characteristic of work module 2. The motion characteristic includes at least any of a size of work module 2, a weight of work module 2, a position of the center of gravity of work module 2, a running resistance of mobile module 1, and a relative position of a work tool 21, which will be described later, to mobile module 1. In other words, the motion characteristic is a motion parameter of work module 2.

Mobile module 1 is configured to be self-propelled on floor 300 by self-propelling portion 12. Self-propelling portion 12 includes, for example, two wheels (two-wheel) as driving wheels. In this case, self-propelling portion 12 is configured to travel in a straight line, rotate, and turn. Self-propelling portion 12 may include, for example, omni-wheels® as driving wheels. In this case, self-propelling portion 12 is movable in all directions in a plane of floor 300. Self-propelling portion 12 may further include a suspension structure. Thus, a load is evenly applied to the driving wheels, thereby suppressing horizontal sliding of the driving wheels.

Floor sensor 13 is configured to detect a marker 4 arranged on floor 300. Floor sensor 13 includes, for example, a camera, a line sensor, an eddy current sensor, or the like. As floor sensor 13 detects marker 4, a relative position of self-propelled robot 100 to floor 300 is detected. Although marker 4 is circular in FIG. 1, marker 4 may be, for example, linear. Linear markers 4 may be arranged in a grid pattern. Marker 4 may have brightness or color different from that of its surroundings. Marker 4 may be made of metal. In this case, floor sensor 13 is configured to detect marker 4 with the eddy current sensor. Structure 200 is arranged in an arrangement area 301 in which a plurality of markers 4 are arranged. In FIG. 1, the outer shape of arrangement area 301 is indicated by the alternate long and short dash line.

Work module 2 is configured to perform work on structure 200. Work module 2 is configured to automatically perform work on structure 200. Self-propelled robot 100 includes a plurality of work modules 2. Each of work modules 2 is configured to perform different work on structure 200. In the present embodiment, self-propelled robot 100 is configured as a self-propelled robot system including at least one mobile module 1 and a plurality of work modules 2.

Work modules 2 include, for example, a first work module 2a, a second work module 2b, and a third work module 2c. First work module 2a is configured to perform precise work upward on structure 200. Second work module 2b is configured to perform sanding. Third work module 2c is equipped with an arm-shaped robot.

Work module 2 is mainly configured to perform work upward on structure 200 from below structure 200. As will be described later, work module 2 may be configured to perform work downward on structure 200 from above structure 200.

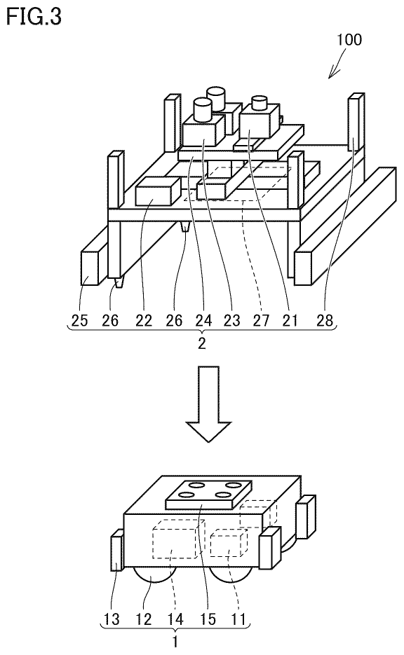

Each of work modules 2 mainly includes work tool 21. Each of work modules 2 further includes a control device 22, a first sensor 23, an actuator 24, a bumper 25, a self-standing mechanism 26, a second port 27 (see FIG. 3), and a second sensor 28.

Work tool 21 is configured to perform work on structure 200. The type of work by work tool 21 is different for each work module 2. Examples of the types of work by work tool 21 include photographing, tightening of a nut, detection of structure 200, detection of floor 300, application of a liquid, spraying of a liquid, cleaning of structure 200, cleaning of floor 300, polishing of structure 200, welding of structure 200, and ultrasonic probing of structure 200. Examples of work tool 21 include a camera, a nutrunner, a probe, an applicator, a liquid sprayer, a cleaner, a sanding device, a welder (e.g., spot welder), and an ultrasonic probe. The types of work by work tool 21 are not limited to the above and may be a combination thereof.

Control device 22 is configured to control work tool 21 according to the type of work by work tool 21. Control device 22 is configured to control work tool 21 in cooperation with controller 11. The configuration of control device 22 will be described later in detail.

First sensor 23 is configured to recognize a position of structure 200. First sensor 23 is configured to recognize a relative position of structure 200 to work module 2. First sensor 23 includes, for example, a camera. Second sensor 28 is configured to measure an angle of structure 200 with respect to work tool 21.

Actuator 24 is configured to move work tool 21 along at least two directions crossing each other. Actuator 24 is configured to move work tool 21 along two directions orthogonal to each other in the in-plane direction of floor 300. Actuator 24 may be configured to move work tool 21 along three directions, that is, two directions in the plane of the floor and the vertical direction. Actuator 24 is configured to move first sensor 23 as well. Actuator 24 is configured to cause work tool 21 to approach structure 200 based on the position of structure 200 which is recognized by first sensor 23.

Desirably, the accuracy of movement of work tool 21 by actuator 24 is higher than the accuracy of movement of mobile module 1. In other words, the minimum unit of movement of work tool 21 by actuator 24 is smaller than the minimum unit of movement of mobile module 1.

Self-standing mechanism 26 is configured to cause the entire work module 2 to stand on its own. In other words, work module 2 is configured to stand on its own. The details of self-standing of work module 2 will be described later.

Bumper 25 is arranged on the outer perimeter of mobile module 1. Although bumper 25 is arranged partially on the outer perimeter of mobile module 1 in FIG. 1, bumper 25 may surround the entire perimeter of mobile module 1. Bumper 25 is configured to detect contact when bumper 25 contacts any other object. Bumper 25 is configured to transmit a signal to mobile module 1 upon bumper 25 detecting contact. Mobile module 1 is configured to stop or perform an evasive action based on a signal transmitted from bumper 25.

Structure 200 is, for example, a spacecraft component such as a solar panel, a structure panel, or an antenna for satellites. The dimensions of structure 200 are, for example, greater than or equal to 2 m and less than or equal to 100 m. In the present embodiment, structure 200 has a plurality of feature points 5 for image recognition. Examples of feature points 5 may include holes and marks printed by a plotter or the like. Feature points 5 may be points by which the outer shape of structure 200, the center of a circle, a point of intersection of lines, or the like in coordinate data or computer-aided design (CAD) data is determined uniquely.

As shown in FIG. 2, work module 2 is configured to be detachable from mobile module 1. Each of work modules 2 is configured to be detachable from mobile module 1. Attachment and detachment of mobile module 1 to and from work module 2 may be automated. In other words, attachment and detachment of work module 2 to and from mobile module 1 may be performed without any manual intervention. The process of attaching and detaching work module 2 to and from mobile module 1 may be, for example, determined in advance. In this case, an instruction regarding the attachment and detachment process can be input from an operation unit of self-propelled robot 100, which is not shown.

As shown in FIG. 3, work module 2 is connected to mobile module 1 from above mobile module 1. First port 15 of mobile module 1 is configured to be connected to work module 2. Desirably, first port 15 is configured to be fixed to work module 2. First port 15 is configured to be mechanically connected to work module 2. First port 15 is configured to be electrically connected to work module 2. First port 15 is configured to supply a power supply to work module 2. The power supply of work module 2 may be battery 14 of mobile module 1, which is supplied via first port 15 and second port 27, or may be a power supply externally supplied via a line. First port 15 is configured to monitor an operating state of work module 2. First port 15 is configured to transmit an operation command to work module 2. In other words, first port 15 has a function to communicate with work module 2.

Though not shown, first port 15 may include a coupling portion electrically connected to second port 27. The coupling portion includes a supply portion that supplies a power supply to second port 27 and a communication portion that communicates with second port 27. The supply portion is, for example, a connector coupled upon contact, such as a contact probe. The communication portion may be, for example, a contact probe, or contactless optical communications, a near field wireless communication technique, or the like may be used as the communication portion.

Though not shown, first port 15 may include a guide portion for guiding second port 27 to the coupling portion of first port 15. The guide portion is, for example, a recessed portion or a projecting portion that is engaged with second port 27. Consequently, even when first port 15 and second port 27 are misaligned, second port 27 is coupled to first port 15 at an accurate position by the guide portion.

Second port 27 is configured to be connected to first port 15. Second port 27 faces first port 15 vertically. Mobile module 1 is configured to be connected to work module 2 with first port 15 and second port 27 facing each other vertically. Though not shown, second port 27 may include a floating mechanism. The floating mechanism includes, for example, a leaf spring. Consequently, a load of second port 27 on first port 15 can be distributed.

The center of gravity of work module 2 is located above mobile module 1. Desirably, in top view of self-propelled robot 100, the center of gravity of work module 2 is arranged inside the area in which mobile module 1 is arranged. More desirably, in top view of self-propelled robot 100, the center of gravity of work module 2 is arranged inside the area in which self-propelling portion 12 is arranged.

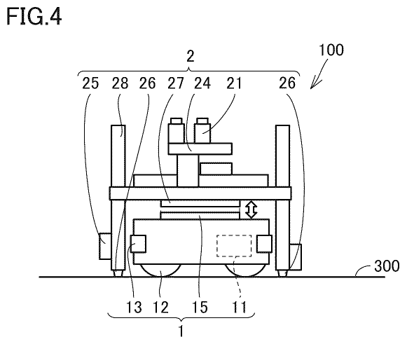

As shown in FIG. 4, work module 2 is detachable from mobile module 1 while standing on its own. Work module 2 is detachable from mobile module 1 while standing on its own by self-standing mechanism 26. Self-standing mechanism 26 is configured to cause work module 2 to stand on its own relative to floor 300 on which mobile module 1 is located even when work module 2 is not supported by mobile module 1. In the present embodiment, work module 2 standing on its own means a state in which work module 2 is supported relative to floor 300 while work module 2 is not connected to mobile module 1.

Self-standing mechanism 26 is arranged at a position at which self-standing mechanism 26 does not interfere with mobile module 1. Self-standing mechanism 26 includes, for example, a plurality of leg portions or wheels. The structure of self-standing mechanism 26 depends on the dimensions of work tool 21 and work module 2.

Though not shown, it is preferable that, in top view of self-propelled robot 100, self-standing mechanism 26 include wheels when the center of gravity of work module 2 is arranged outside the area in which self-propelling portion 12 is arranged. In this case, the load due to the self-weight of work module 2 is released to floor 300 without the intervention of mobile module 1.

First port 15 is configured to move from a position lower than second port 27 to a position higher than second port 27. First port 15 is configured to move vertically. The vertical movement of first port 15 may be controlled by force control based on a load applied to first port 15. Specifically, one example of force control is a control method of, for example, driving first port 15 by a servomotor and reading a current value of a current flowing through the servomotor. Though not shown, the plurality of leg portions may be configured to extend and contract vertically. In this case, first port 15 does not need to move vertically.

A load applied to self-propelling portion 12 of mobile module 1 may be variably controlled according to work module 2. In this case, a fear of slipping of self-propelling portion 12 can be reduced. Also, work can become faster by accommodating acceleration and deceleration. Further, even when work module 2 is heavy, the load applied to self-propelling portion 12 can be suppressed, thus reducing a load applied to self-propelling portion 12.

### <Configurations and Control of Controller 11 and Control Device 22>

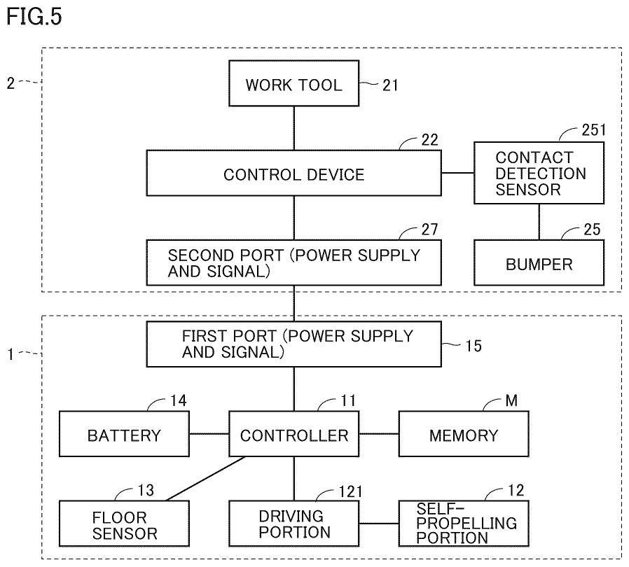

As shown in FIG. 5, controller 11 is connected to a driving portion 121 connected to self-propelling portion 12, floor sensor 13, battery 14, and a memory M. Controller 11 is configured to control self-propelling portion 12, floor sensor 13, and battery 14. Respective parameters (motion characteristics) of work modules 2, positional information of structure 200 which is used by controller 11 for movement of mobile module 1 and work of work module 2, and the like are stored in memory M. Controller 11 is configured to transmit and receive a power supply and a signal between first port 15 and second port 27. First port 15 is connected with the power supply. Controller 11 is configured to control work module 2 via first port 15.

Control device 22 is connected to work tool 21, second port 27, and a contact detection sensor 251 connected to bumper 25. Control device 22 is configured to control work tool 21, second port 27, and bumper 25. Control device 22 is configured to transmit and receive a power supply and a signal between first port 15 and second port 27. Second port 27 is connected with a power supply. Control device 22 may be configured to control driving of actuator 24. In this case, control device 22 may switch actuator 24 to ON state or OFF state or may perform feedback control.

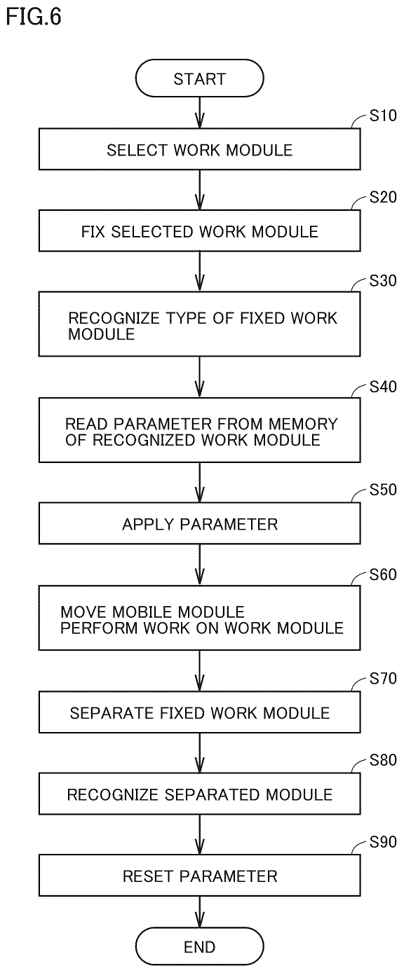

As shown in FIG. 6, controller 11 controls movement of mobile module 1 and work of work module 2 according to the following procedure. First, work module 2 connected to mobile module 1 is selected from among work modules 2 (S10). In FIG. 1, a first work module 2a is selected. Subsequently, the selected work module 2 is fixed (connected) to mobile module 1 (S20). Controller 11 recognizes the type of the fixed work module 2 (S30). Controller 11 recognizes the type of work module 2 by, for example, reading information of work module 2 from control device 22. Controller 11 reads a parameter (motion characteristic) of the fixed work module 2 from memory M (S40). Controller 11 applies the parameter (motion characteristic) of work module 2 (S50). With the parameter (motion characteristic) applied, mobile module 1 moves, and work module 2 performs work on structure 200 (S60). The movement and work will be described later in detail. After the completion of movement and work, work module 2 is separated from mobile module 1 (S70). Controller 11 recognizes that work module 2 has been separated from mobile module 1 (S80). Controller 11 resets the applied parameter (motion characteristic) (S90).

### <Method of Manufacturing Structure 200 Using Self-Propelled Robot 100>

Next, a method of manufacturing structure 200 using self-propelled robot 100 according to Embodiment 1 will be described with reference to FIGS. 1 and 7 to 11.

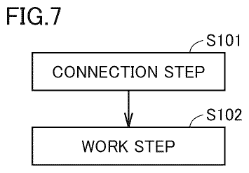

As shown in FIG. 7, the method of manufacturing structure 200 mainly includes a connection step S101 and a work step S102. The method of manufacturing structure 200 may include the step of processing structure 200 prior to connection step S101. The processing step is, for example, the step of processing the outer shape of structure 200 using a three-axis processing machine. As shown in FIG. 1, a plurality of feature points 5 are provided in structure 200 in the processing step.

Structure 200 is vertically spaced apart from floor 300. This vertical spacing is dimensioned to allow self-propelled robot 100 to travel. Structure 200 is arranged inside arrangement area 301 in which markers 4 are arranged. The attitude in the in-plane direction or the attitude in the rotational direction of structure 200 may be displaced as long as structure 200 is arranged inside arrangement area 301. Structure 200 may tilt 3° or less with respect to floor 300. Desirably, structure 200 is arranged parallel to floor 300. Structure 200 may be supported relative to floor 300 by support 3. Though not shown, structure 200 may be spaced apart from floor 300 by being arranged across (to run over) a plurality of work tables.

In connection step S101, mobile module 1 is connected to work module 2. Mobile module 1 is connected to one work module 2 of work modules 2. Controller 11 of mobile module 1 automatically recognizes the type of work module 2. Controller 11 automatically applies an operation program according to a work portion. Controller 11 applies a parameter for vehicle body control of self-propelling portion 12 of mobile module 1 based on a motion characteristic. Examples of the parameter for vehicle body control include a parameter for attitude control reflecting a rate of acceleration in acceleration and deceleration, a maximum speed, and a slip, and a relative position of bumper 25 to the rotation center of mobile module 1.

The worker of self-propelled robot 100 inputs an instruction required for work to be performed to control device 22 of work module 2. At the time of input, operation instruction data based on CAD data of structure 200 may be automatically generated as an instruction required for the work to be performed. The positional information of marker 4 pre-stored in memory M is read as the instruction required for work to be performed.

In work step S102, mobile module 1 moves toward structure 200. In work step S102, controller 11 controls movement of mobile module 1 based on the motion characteristic of work module 2.

In work step S102, self-propelled robot 100 moves from a position at which self-propelled robot 100 can recognize feature point 5 of structure 200 (e.g., at or inside a boundary of arrangement area 301) to a position at which work module 2 performs work on structure 200. Self-propelled robot 100 may be moved manually or automatically to the position at which self-propelled robot 100 recognizes feature point 5 of structure 200.

More specifically, mobile module 1 first moves to a predetermined position. The predetermined position is a position at which self-propelled robot 100 can recognize feature point 5 of structure 200. At the predetermined position, self-propelled robot 100 recognizes the position of feature point 5 of structure 200 and the position of marker 4. It is desirable that self-propelled robot 100 recognize at least two feature points 5 of structure 200. Consequently, for coordinate data of marker 4, the attitude of structure 200 relative to the in-plane direction and the rotational direction can be automatically recognized. Subsequently, the relationship between the instruction required for work to be performed and the position of marker 4 is generated.

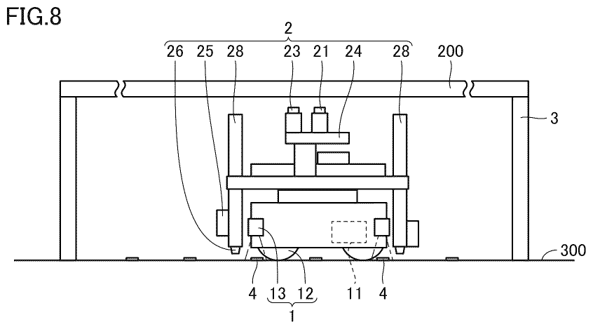

Subsequently, as shown in FIG. 8, mobile module 1 moves to the predetermined position, and then, is aligned with structure 200 relative to marker 4 closest to self-propelled robot 100 among markers 4. Marker 4 closest to self-propelled robot 100 among markers 4 is recognized by floor sensor 13. Floor sensor 13 recognizes, for example, a marker in the area surrounded by the alternate long and short dash line in FIG. 1.

When work that requires highly accurate alignment is performed, steps 1 to 4 described below are repeatedly performed in work step S102. Examples of the work that requires highly accurate alignment include tightening of a bolt, spot welding, and application of an adhesive to a minute area.

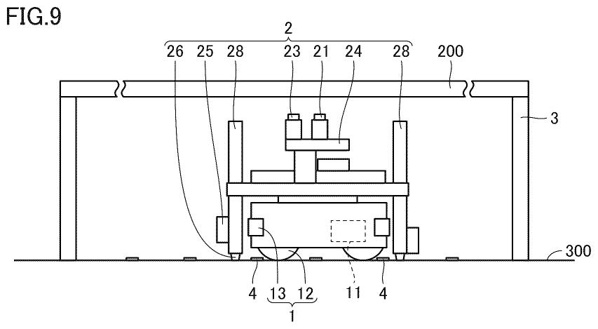

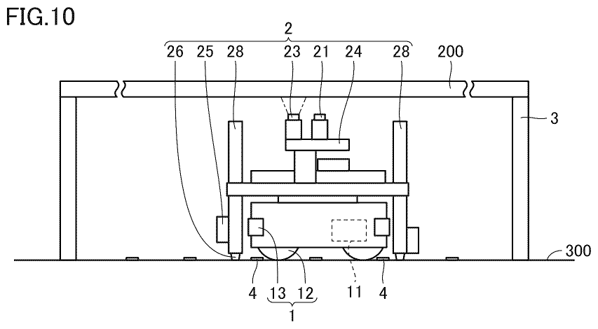

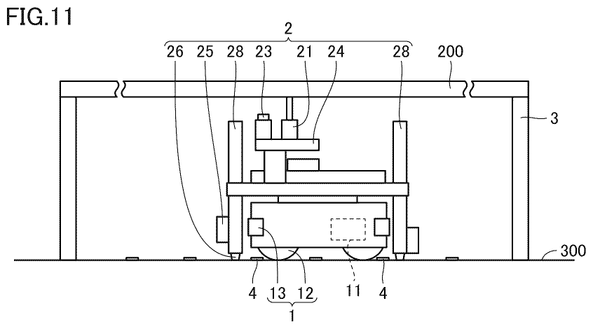

As shown in FIG. 8, in step 1, the position of mobile module 1 is controlled as marker 4 is read by floor sensor 13, and alignment with structure 200 is roughly performed. Subsequently, as shown in FIG. 9, in step 2, work module 2 stands on its own as self-standing mechanism 26 of work module 2 is placed on floor 300. This suppresses the influence of the elasticity of the wheels and spring properties of self-propelling portion 12 of mobile module 1 on work module 2. Subsequently, as shown in FIG. 10, in step 3, a work area of structure 200 and the surroundings of the work area are recognized by first sensor 23. First sensor 23 is configured to, for example, irradiate structure 200 with light. FIG. 10 shows light by the alternate long and short dash line. Consequently, the relative positions of the work area of structure 200 and self-propelled robot 100 are recognized accurately. As shown in FIG. 11, in step 4, work tool 21 is aligned by actuator 24 based on the relative positions obtained in step 3. For example, as actuator 24 moves in the in-plane direction of floor 300, work tool 21 mounted on actuator 24 is aligned.

As shown in FIG. 11, in work step S102, work module 2 performs work on structure 200. In work step S102, controller 11 controls work of work module 2 based on the motion characteristic of work module 2. In work step S102, work module 2 performs work at the aligned position. In the present embodiment, work module 2 performs work upward on structure 200 below structure 200. In FIG. 11, work tool 21 performs work on structure 200 as work tool 21 extends to structure 200. Work module 2 may perform work downward on structure 200 above structure 200 as will be described later, or may perform work horizontally on structure 200 (not shown). In work step S102, work module 2 may inspect structure 200.

After the completion of work by work module 2, self-propelled robot 100 moves apart from structure 200 and then stops. For example, self-propelled robot 100 moves to an end of structure 200 and then stops. For example, the self-propelled robot moves to the outside of arrangement area 301 and then stops.

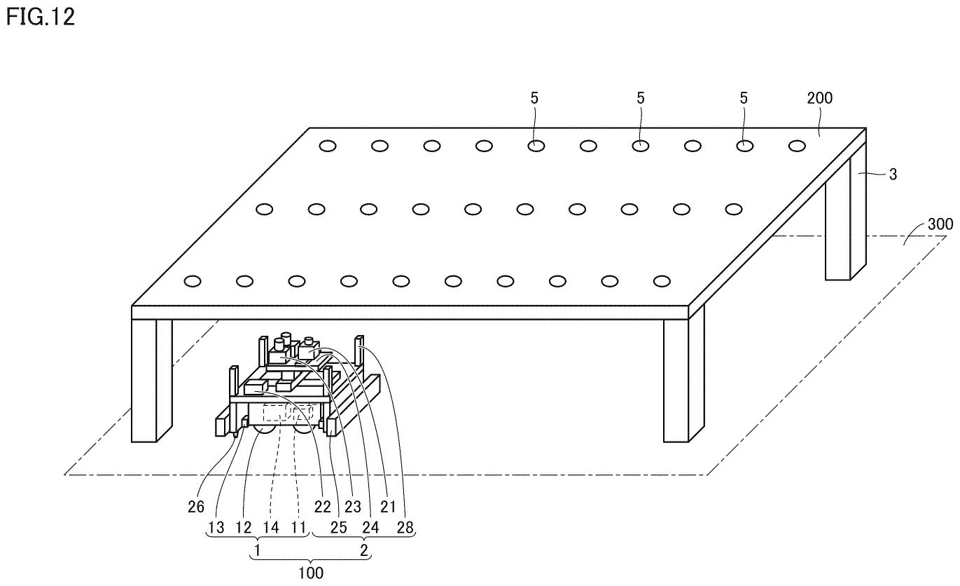

Next, a method of manufacturing structure 200 according to a modification of Embodiment 1 will be described with reference to FIG. 12.

As shown in FIG. 12, in the modification of Embodiment 1, marker 4 (see FIG. 1) is not arranged on floor 300. The spacing between feature points 5 is set so as to sufficiently reduce the influence of straightness and alignment accuracy of self-propelled robot 100 on the tightest alignment accuracy required for structure 200. In work step S102, self-propelled robot 100 can be aligned with structure 200 based on feature points 5 without using a marker (see FIG. 1).

Next, the functions and effects of the present embodiment will be described.

In self-propelled robot 100 according to the present embodiment, as shown in FIG. 1, controller 11 is configured to control movement of mobile module 1 and work of work module 2 based on the motion characteristic of work module 2. Thus, when the motion characteristic of mobile module 1 changes upon switch of work module 2 connected to mobile module 1, movement of mobile module 1 and work of work module 2 are controlled based on the motion characteristic that has changed. This enables stable operations of mobile module 1 and work module 2.

As shown in FIG. 1, a configuration is made such that movement of mobile module 1 and work of work module 2 are controlled based on the motion characteristic of work module 2. A load capacity, which is a weight that mobile module 1 can transport, depends on the weight of work module 2 which is a motion characteristic of work module 2 connected to mobile module 1. Thus, the load capacity of mobile module 1 can be changed based on the motion characteristic (weight) of work module 2. This can suppress work module 2 exceeding the load capacity of mobile module 1.

An output for movement of mobile module 1 depends on the weight of work module 2 and the position of the center of gravity of work tool 21 which are motion characteristics of work module 2. Consequently, the output for movement of mobile module 1 can be changed based on the motion characteristics of work module 2 (the weight of work module 2 and the position of the center of gravity of work tool 21). This can suppress waste of output for movement of mobile module 1.

Whether mobile module 1 can travel a traveling route without deviating from a predetermined traveling route depends on the weight of work module 2 which is a motion characteristic of work module 2. Thus, when the motion characteristic of work module 2 (the weight of work module 2) changes, deviation of the traveling route of mobile module 1 from a target traveling route can be suppressed.

The balance of mobile module 1 depends on the dimensions and weight of work module 2 which are motion characteristics of work module 2. Thus, the position and dimensions of bumper 25 of work module 2 change as work module 2 is replaced, and in the case of the overall weight and dimensions of work module 2 changes, mobile module 1 losing its balance can be suppressed. Also, an evacuation action and an evacuation distance upon detection of a collision can be changed according to the position and dimensions of bumper 25 of work module 2. This enables a stable operation of self-propelled robot 100.

If it is not based on the motion characteristic of work module 2 to control movement of mobile module 1 and work of work module 2, mobile module 1 needs to be designed according to the dimensions of the largest work module 2 among work modules 2 that can be selected, leading to an excessive increase in size of mobile module 1. In contrast, according to the present embodiment, a configuration is made such that movement of mobile module 1 and work of work module 2 are controlled based on the motion characteristic (dimensions) of work module 2, and accordingly, the size of mobile module 1 can be reduced according to work module 2 selected. This can suppress an excessive increase in size of mobile module 1.

As shown in FIG. 1, each of work modules 2 is detachable from mobile module 1, and the type of work by work tool 21 is different for each work module 2. Thus, upon switch of work module 2 connected to one mobile module 1, multiple pieces of work can be performed by one mobile module 1.

The motion characteristic includes at least any of a size of work module 2, a weight of work module 2, a position of the center of gravity of work module 2, a running resistance of mobile module 1, and a relative position of work tool 21 to mobile module 1. Contact of work module 2 with an object therearound can be suppressed based on the size of work module 2. Slip can be suppressed, and further, an amount of slip can be predicted, by calculating a normal load on self-propelling portion 12 based on the weight of work module 2 or the position of the center of gravity of work tool 21. An amount of torque applied to self-propelling portion 12 can be controlled appropriately based on the running resistance of mobile module 1. The position of work tool 21 relative to structure 200 can be controlled optimally based on the relative position of work tool 21 to mobile module 1.

As shown in FIG. 1, actuator 24 is configured to cause work tool 21 to approach structure 200 based on the position of structure 200 which is recognized by first sensor 23, and the accuracy of movement of work tool 21 by actuator 24 is higher than the accuracy of movement of mobile module 1. Therefore, work tool 21 can be aligned with structure 200 with higher accuracy than when work tool 21 is aligned with structure 200 only by movement of mobile module 1.

As shown in FIG. 4, work module 2 is configured to stand on its own. This can suppress toppling over of self-propelled robot 100. Also, variations in load applied to self-propelling portion 12 of work module 2 can be suppressed.

As shown in FIG. 4, work module 2 is detachable from mobile module 1 while standing on its own. Thus, mobile module 1 can be attached to work module 2 as mobile module 1 is moved upward, and mobile module 1 can be detached from work module 2 as mobile module 1 is moved downward. Thus, work module 2 can be attached to and detached from mobile module 1 automatically (without any manual intervention). This allows work modules 2 used for work in different steps to be automatically attached to and detached from one mobile module 1. Also, this eliminates the use of a module station that may be used in attachment and detachment of work module 2 to and from mobile module 1.

According to the method of manufacturing structure 200 of the present embodiment, as shown in FIG. 1, controller 11 controls movement of mobile module 1 based on the motion characteristic of work module 2 in work step S102 and controls work of work module 2 based on the motion characteristic of work module 2 in work step S102. Thus, even when the motion characteristic changes upon switch of work module 2, movement of mobile module 1 and work of work module 2 are controlled based on the motion characteristic that has changed. This enables a stable operation of self-propelled robot 100.

As shown in FIG. 1, mobile module 1 moves toward structure 200 in work step S102. This eliminates the need for moving structure 200. Accordingly, a facility for moving structure 200 to self-propelled robot 100 does not need to be provided. Thus, the size of self-propelled robot 100 can be reduced. Also, the facility for moving structure 200 is not necessary, thus eliminating the need for, for example, a large gantry crane or a long-distance-driven actuator, or the like. Also, mobile module 1 can move relative to the entire structure 200, enabling automation of work on the entire structure 200.

As shown in FIG. 8, mobile module 1 moves to the predetermined position, and then, is aligned with structure 200 relative to marker 4 closest to self-propelled robot 100 among markers 4. Thus, self-propelled robot 100 can be aligned using both of structure 200 and marker 4. This enables accurate alignment. For example, in structure 200 such as a solar panel in which the same shape is repeated in a grid pattern, when alignment is performed only relative to structure 200, self-propelled robot 100 may be out of alignment by one column in the grid due to the influence of slip, erroneous detection, or the like. In contrast, the present embodiment, which uses both of structure 200 and marker 4, can suppress misalignment of a column of a gird arranged.

In work step S102, work module 2 may inspect structure 200. In this case, a stable inspection is enabled. Therefore, structure 200 can be inspected with high accuracy.

### Embodiment 2

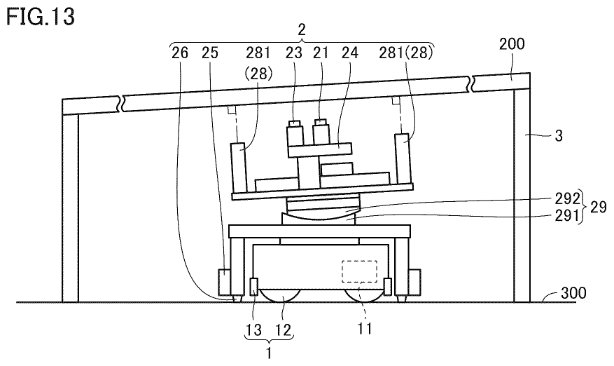

Next, a configuration of a self-propelled robot 100 according to Embodiment 2 will be described with reference to FIG. 13. Unless otherwise specified, Embodiment 2 has the same components, the same method of manufacturing structure 200, and the same functions and effects as those of Embodiment 1 described above. Therefore, the same components as those of Embodiment 1 have the same reference characters, and description thereof will not be repeated.

As shown in FIG. 13, in self-propelled robot 100 according to the present embodiment, work module 2 includes a second sensor 28 and a tilt mechanism 29.

Second sensor 28 is configured to measure an angle of structure 200 with respect to work tool 21. Second sensor 28 includes, for example, a plurality of laser displacement meters 281. Each of laser displacement meters 281 is configured to measure the distance from structure 200 to work tool 21 using a laser. In FIG. 13, the laser of laser displacement meter 281 is indicated by the alternate long and short dash line.

Tilt mechanism 29 is configured to tilt work tool 21 and second sensor 28 with respect to floor 300. Tilt mechanism 29 includes, for example, a goniometer stage (tilt stage).

In the present embodiment, tilt mechanism 29 includes a first tilt portion 291 and a second tilt portion 292. First tilt portion 291 is connected to self-standing mechanism 26. First tilt portion 291 is provided in parallel to floor 300. Second tilt portion 292 is configured to tilt with respect to first tilt portion 291. Work tool 21, actuator 24, first sensor 23, and second sensor 28 are mounted in second tilt portion 292. Second tilt portion 292 is configured to tilt relative to first tilt portion 291 to tilt work tool 21, first sensor 23, actuator 24, and second sensor 28 with respect to floor 300.

Controller 11 is configured to control a direction of work tool 21 based on an angle measured by second sensor 28. Specifically, controller 11 controls tilt mechanism 29 based on the angle between structure 200 and work tool 21, which is measured by second sensor 28, such that work tool 21 is orthogonal to structure 200, thereby controlling the direction of work tool 21. More specifically, controller 11 tilts tilt mechanism 29 so as to minimize the distance between structure 200 and the respective positions of laser displacement meters 281 which are measured by laser displacement meters 281, thereby causing work tool 21 to be orthogonal to structure 200.

Next, the functions and effects of the present embodiment will be described.

In self-propelled robot 100 according to the present embodiment, as shown in FIG. 13, controller 11 is configured to control a direction of work tool 21 based on an angle measured by second sensor 28. Thus, even when an angle of work tool 21 with respect to structure 200 is an undesirable angle, the angle of work tool 21 with respect to structure 200 can be changed to a desirable angle by controlling a direction of work tool 21. Specifically, even when structure 200 is tilted with respect to work tool 21, work tool 21 can be made orthogonal to structure 200. This enables alignment of work tool 21 with structure 200 with high accuracy even when structure 200 is tilted with respect to work tool 21. Also, work can be performed with high accuracy. For example, when structure 200 is deformed by its self-weight or when floor 300 is undulating (is distorted), structure 200 is tilted with respect to work tool 21. Also, even when structure 200 has a curved shape, optimum work can be performed on the curved surface by controlling an angle of work tool 21 to be orthogonal to the curved surface. For example, structure 200 of cylindrical shape, such as a satellite central cylinder, or structure 200 such as an antenna, has a curved shape.

### Embodiment 3

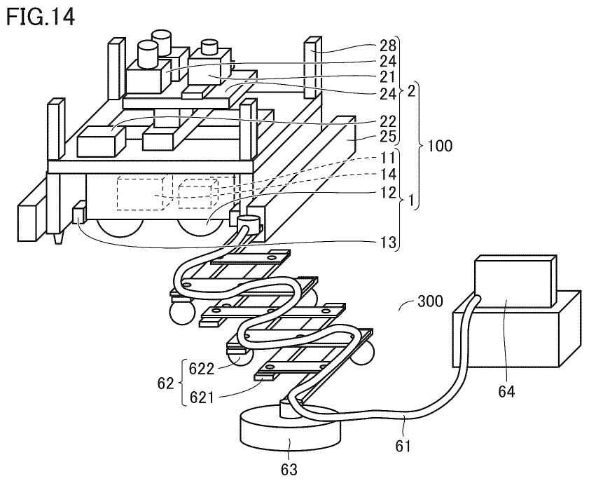

Next, a configuration of a self-propelled robot 100 according to Embodiment 3 will be described with reference to FIG. 14. Unless otherwise specified, Embodiment 3 has the same components, the same method of manufacturing structure 200, and the same functions and effects as those of Embodiment 1 described above. Therefore, the same components as those of Embodiment 1 have the same reference characters, and description thereof will not be repeated.

As shown in FIG. 14, self-propelled robot 100 according to the present embodiment further includes a cable 61 and a cable platform 62.

Cable 61 is connected to any of mobile module 1 and work module 2. One end of cable 61 is connected to any of mobile module 1 and work module 2. The other end of cable 61 is connected to an external device 64 or a building (not shown). Cable 61 is, for example, a power cable, a cable for supplying compressed air, an optical fiber for supplying laser light, a signal line, or the like. Cable 61 is configured to move according to movement of mobile module 1.

Cable platform 62 is configured to extend and contract according to movement of mobile module 1 while supporting cable 61. Specifically, cable platform 62 includes, for example, an extension and contraction mechanism 621 configured to extend and contract, such as a manipulator, and a wheel 622 configured to be self-propelled on floor 300, such as a caster. Cable 61 is supported on extension and contraction mechanism 621. One end of cable platform 62 is connected to any of mobile module 1 and work module 2. One end of cable platform 62 is rotatable relative to any of mobile module 1 and work module 2. The other end of cable platform 62 is connected to a fixed portion 63 fixed to floor 300. The other end of cable platform 62 is rotatable relative to fixed portion 63. Cable platform 62 is configured to extend and contract in the radial direction of fixed portion 63. Cable platform 62 is rotatable freely in the circumferential direction of fixed portion 63.

Next, the functions and effects of the present embodiment will be described.

In self-propelled robot 100 according to the present embodiment, as shown in FIG. 14, cable platform 62 is configured to extend and contract according to movement of mobile module 1 while supporting cable 61. This can suppress rubbing of cable 61 against floor 300 when mobile module 1 moves. This can suppress damage to cable 61. Also, since damage to cable 61 can be suppressed, even work tool 21 or cable 61 that is not complete only within work module 2, such as high-voltage equipment, high-voltage equipment, or an optical fiber for laser welding, can be mounted in work module 2 while being connected to external device 64, for automation.

### Embodiment 4

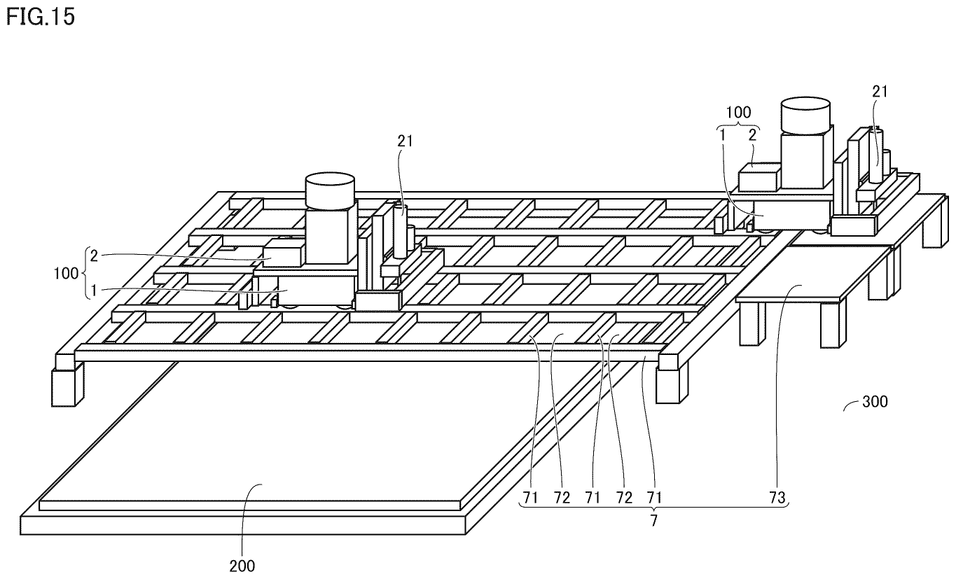

Next, a method of manufacturing a structure 200 according to Embodiment 4 will be described with reference to FIG. 15. Unless otherwise specified, Embodiment 4 has the same method of manufacturing structure 200, and the same functions and effects as those of Embodiment 1 described above. Therefore, the same components as those of Embodiment 1 have the same reference characters, and description thereof will not be repeated.

As shown in FIG. 15, according to the method of manufacturing structure 200 of the present embodiment, mobile module 1 moves on a frame portion 7 covering structure 200. Work module 2 performs work downward on structure 200 from above frame portion 7.

Frame portion 7 is configured to mount self-propelled robot 100 thereon. Frame portion 7 includes a plurality of beam portions 71 and an evacuation portion 73. Beam portions 71 are arranged to cross each other. Beam portions 71 are arranged, for example, to be orthogonal to each other. In this case, self-propelling portion 12 of mobile module 1 includes, for example, wheels that can switch the direction of movement by 90° for travel, two wheels in two directions orthogonal to each other, or omni-wheels®. Beam portions 71 are spaced apart from each other. The spacing between beam portions 71 may be the same as the spacing between the wheels of self-propelling portion 12 of mobile module 1.

Beam portions 71 are formed of, for example, a frame made of aluminum (Al). Beam portions 71 form a grid. Beam portions 71 cross each other to form a plurality of hole portions 72 as holes in the grid. Work module 2 is accessible to structure 200 through each of hole portions 72. Hole portion 72 is provided in, for example, a rectangular shape.

Though not shown, a plurality of frame markers may be arranged in frame portion 7. Each of the plurality of frame markers is arranged at, for example, a position at which beam portions 71 cross each other. As self-propelled robot 100 detects a position of a frame marker closest to self-propelled robot 100, self-propelled robot 100 can detect a current position of self-propelled robot 100. For example, self-propelled robot 100 can detect a position in the grid at which self-propelled robot 100 is currently positioned.

Evacuation portion 73 is connected with beam portions 71. Evacuation portion 73 is arranged outside beam portions 71. Evacuation portion 73 has such dimensions that allow self-propelled robot 100 to be arranged thereon. As self-propelled robot 100 is temporarily evacuated to evacuation portion 73, work module 2 can be replaced or receive maintenance without interfering with the work on frame portion 7.

Frame portion 7 may entirely cover structure 200 or partially cover structure 200. When frame portion 7 partially covers structure 200, as frame portion 7 or structure 200 is moved after the completion of work in an area of structure 200 which is covered with frame portion 7, work can be performed on the entire structure 200 without increasing the size of frame portion 7.

Since work module 2 accesses structure 200 from above frame portion 7, its access may be interfered by beam portions 71 in some areas, depending on the design of work module 2 and the design of frame portion 7. In this case, the area, access to which is interrupted by beam portions 71, can be eliminated by changing the relative positions of beam portions 71 and structure 200. This allows work module 2 to access the entire area of structure 200.

Next, the functions and effects of the present embodiment will be described.

According to the method of manufacturing structure 200 of the present embodiment, as shown in FIG. 15, work module 2 performs work downward on structure 200 from above frame portion 7. This can allow work module 2 to easily access structure 200 from above structure 200. Thus, work that is difficult (e.g., application of a low-viscosity adhesive) when structure 200 is accessed from below structure 200 can be performed from above structure 200.

Mobile module 1 moves on frame portion 7. This eliminates the need for frame portion 7 to move self-propelled robot 100. In other words, frame portion 7 does not need to include an actuator. Therefore, automation of work by self-propelled robot 100 using frame portion 7 can be performed easily and inexpensively.

### Embodiment 5

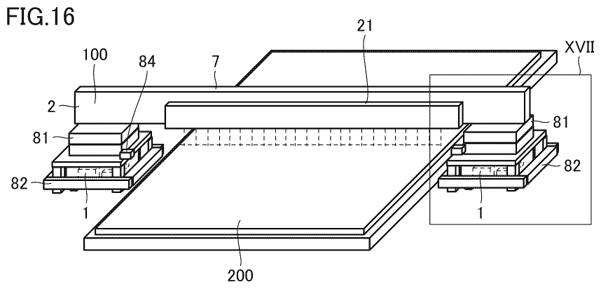

Next, a method of manufacturing structure 200 according to Embodiment 5 will be described with reference to FIG. 16. Unless otherwise specified, Embodiment 5 has the same method of manufacturing structure 200, and the same functions and effects as those of Embodiment 1 described above. Therefore, the same components as those of Embodiment 1 have the same reference characters, and description thereof will not be repeated.

As shown in FIG. 16, according to a method of manufacturing structure 200 of the present embodiment, self-propelled robot 100 includes, at least, work module 2 and a plurality of mobile modules 1. Specifically, work module 2 is detachable from two mobile modules 1. Work module 2 includes frame portion 7 and two accommodation portions 82. Work tool 21 is provided to frame portion 7. Two accommodation portions 82 are arranged at the opposite ends of frame portion 7. Accommodation portion 82 can accommodate mobile module 1. First port 15 (see FIG. 3) of mobile module 1 is coupled to second port 27 (see FIG. 3) of work module 2 so as to be fitted in accommodation portion 82. In this manner, work module 2 is connected to each of the two mobile modules 1. In other words, work module 2 is detachably connected to the two mobile modules 1.

As shown in FIG. 16, frame portion 7 is a belt-shaped or columnar member running in one direction. The length of frame portion 7 is longer than the length of one side of structure 200. When two mobile modules 1 are connected to work module 2, frame portion 7 is arranged higher than structure 200. In other words, when two mobile modules 1 are connected to work module 2, the two mobile modules 1 are spaced apart from each other so as to sandwich structure 200 therebetween. This creates a space in which self-propelled robot 100 according to the present embodiment can straddle structure 200. Also, in this state, work tool 21 provided to frame portion 7 is arranged so as to face structure 200.

When work module 2 is not connected to mobile module 1, work module 2 may include, for example, a self-standing mechanism. The self-standing mechanism is, for example, a wheel or an adjuster pad.

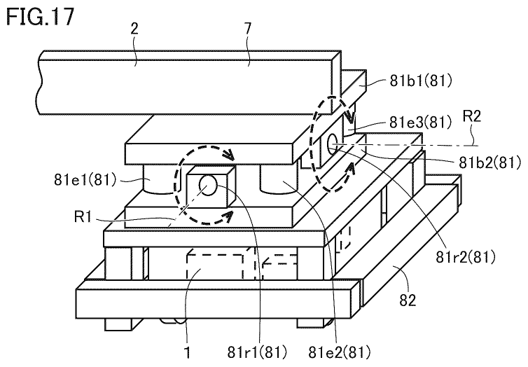

Work module 2 may include a floating mechanism 81 between second port 27 and frame portion 7. Specifically, as shown in FIG. 17, floating mechanism 81 includes a first connection portion 81b1, a second connection portion 81b2, an elastic body, and a shaft of rotation. Floating mechanism 81 may have a structure in which a plurality of elastic bodies are arranged between second port 27 and frame portion 7. Specifically, first connection portion 81b1 and second connection portion 81b2 are each connected to the plurality of elastic bodies. From a different perspective, first connection portion 81b1 and second connection portion 81b2 are arranged while facing each other so as to sandwich a plurality of elastic bodies therebetween. As shown in FIG. 17, first connection portion 81b1 and second connection portion 81b2 are, for example, flat plates. The flat surface shapes of first connection portion 81b1 and second connection portion 81b2 are, for example, rectangular shapes. The number of elastic bodies is, for example, four. The elastic bodies include a first elastic body 81e1, a second elastic body 81e2, a third elastic body 81e3, and a fourth elastic body. First elastic body 81e1, second elastic body 81e2, third elastic body 81e3, and the fourth elastic body (not shown) are positioned, for example, so as to respectively face four corners of first connection portion 81b1. First connection portion 81b1 is connected to frame portion 7 on the surface opposite to the surface facing the elastic bodies. Second connection portion 81b2 is connected to accommodation portion 82 on the surface opposite to the surface connected to the elastic bodies. Floating mechanism 81 may have a structure in which, for example, a two-axis shaft of rotation is arranged between second port 27 and frame portion 7. Specifically, as shown in FIG. 17, the shaft of rotation includes a first shaft of rotation 81r1 and a second shaft of rotation 81r2. First shaft of rotation 81r1 and second shaft of rotation 81r2 are arranged so as to be sandwiched between first connection portion 81b1 and second connection portion 81b2. First shaft of rotation 81r1 is revolvable about a central axis R1. Second shaft of rotation 81r2 is revolvable about a central axis R2. First shaft of rotation 81r1 and second shaft of rotation 81r2 extend such that central axis R1 and central axis R2 are orthogonal to each other. Floating mechanism 81 has a so-called gimbal structure including first shaft of rotation 81r1 and second shaft of rotation 81r2 that are orthogonal to each other. First shaft of rotation 81r1 may be arranged between first elastic body 81e1 and second elastic body 81e2. First shaft of rotation 81r1 may be arranged between the fourth elastic body and third elastic body 81e3. Second shaft of rotation 81r2 may be arranged between first elastic body 81e1 and the fourth elastic body. Second shaft of rotation 81r2 may be arranged between second elastic body 81e2 and third elastic body 81e3. As described above, when floating mechanism 81 has the gimbal structure including the elastic bodies and the shafts of rotation, floating mechanism 81 experiences a restoring force as to return to horizontal even if the surfaces of frame portion 7 and second port 27, which face each other, tilt. The restoring force is generated, for example, by the elastic body as described above. The elastic body is, for example, a spring.

For example, when the surface on which mobile module 1 travels is not flat (e.g., is undulating), the surfaces of second port 27 at the opposite ends of work module 2 may tilt with respect to each other. As a result, the load of work module 2 may be unevenly applied to the wheels of mobile module 1. As floating mechanism 81 is provided, the respective surfaces of second port 27 to which two mobile modules 1 are fixed tilt in correspondence with the shape of the surface on which mobile module 1 travels. This can substantially equalize the load of work module 2 applied to the respective wheels of two mobile modules 1.

When floating mechanism 81 has a structure with a shaft of rotation, the position of the rotational center of the shaft of rotation is preferably located at the same height as the position of the center of gravity of work module 2. Specifically, it suffices that the center of gravity of work module 2 is located on the extension of central axis R2. As the rotational center of the shaft of rotation is located at the same height as the position of the center of gravity of work module 2, even when work module 2 tilts with respect to the surface on which mobile module 1 travels, an angle by which work module 2 tilts with respect to the surface on which mobile modules 1 travels can be minimized. Thus, vibrations of work module 2 caused by movement of mobile module 1 can be reduced.

Control of self-propelled robot 100 according to the present embodiment will be described. In self-propelled robot 100 according to the present embodiment, two mobile modules 1 need to move in synchronization with each other. Two mobile modules 1 may share the type of operation, various control parameters, a current attitude, and trigger signals wirelessly or by wire. Sharing of signals by wire may be performed by a signal line arranged via work module 2.

In attitude control of mobile module 1, any one mobile module 1 of two mobile modules 1 serves as a master. The other mobile module 1 serves as a slave. Mobile module 1 serving as a slave operates in accordance with the motion of mobile module 1 serving as a master.

The parameters such as a weight of work module 2, a running resistance, and a distance between two mobile modules 1 vary depending on the type of work module 2. As such parameters are stored in the memory of work module 2, when these parameters are read in connection of work module 2 and mobile module 1, the same mobile module 1 can be used for work modules 2 of different types.

As shown in FIG. 16, self-propelled robot 100 may include a third sensor 84 such as a camera or a laser displacement meter, if necessary. With the use of third sensor 84, the relative positions of structure 200 and work module 2 are recognized. As a result, the operation of mobile module 1 can be controlled so as to prevent a collision between self-propelled robot 100 and structure 200.

As shown in FIG. 16, large-size work tool 21 is mounted along frame portion 7. As shown in FIG. 16, work tool 21 uniformly processes the top surface of structure 200. Work tool 21 may be, for example, a head that performs atmospheric-pressure plasma processing or a contact image sensor (CIS) that performs image processing, and may be any other tool. Thus, as work module 2 is operated while driving self-propelled robot 100, structure 200 with a large surface can be processed or inspected.

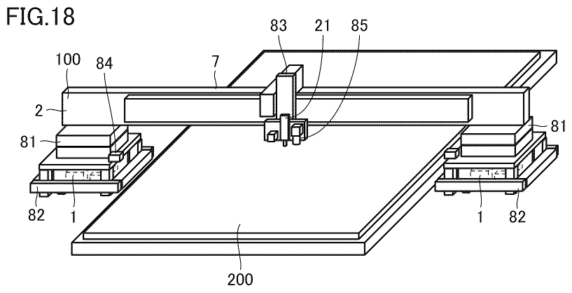

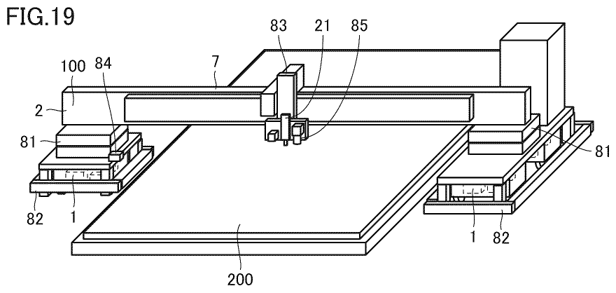

Next, a method of manufacturing a structure 200 according to a modification of Embodiment 5 will be described with reference to FIGS. 18 and 19.

As shown in FIG. 18, work module 2 may include a drive shaft 83 with high positioning accuracy. Drive shaft 83 is connected to frame portion 7. Drive shaft 83 runs vertically to the surface of structure 200 which is a target area in which work tool 21 performs work on structure 200. At an end of drive shaft 83 which is closer to structure 200, work tool 21 and a fourth sensor 85 such as a camera may be placed.

As shown in FIG. 19, self-propelled robot 100 may include three mobile modules 1. When the self-weight of work module 2 is large, a plurality of mobile modules 1 are preferably connected to work module 2. As described above, for one work module 2, the number of mobile modules 1 connected to work module 2 may be three or more in accordance with the size or weight of work module 2.

Next, the functions and effects of the present embodiment will be described.

Self-propelled robot 100 according to the present embodiment is configured to include a plurality of mobile modules 1 as shown in FIGS. 16 to 19. Work module 2 is detachable from mobile modules 1. Thus, when it is difficult to perform work on structure 200 by accessing structure 200 from therebelow or when the self-weight of structure 200 is heavy and structure 200 cannot stand on its own, work module 2 can be arranged stably above structure 200 by mobile modules 1. Therefore, self-propelled robot 100 can perform work on structure 200 from above structure 200.

For example, when a workpiece is attached on a panel, work module 2 increases in size, thus increasing the self-weight of work module 2. Even in such a case, self-propelled robot 100 according to the present embodiment can stably move work module 2 by causing mobile modules 1 to cooperate with each other. Also, work can be performed using mobile module 1 that has the same size and load bearing property as those of mobile module 1 that has moved a small-size work module 2. This eliminates the need for preparing mobile module 1 corresponding to respective work. In other words, mobile modules 1 of one type are prepared and the number of mobile modules 1 can be adjusted as appropriate, leading to efficient production and efficient maintenance.

Work module 2 uses frame portion 7 running only in one direction. This enables work on one structure 200 by simultaneously using work modules 2. Also, when work module 2 has a structure such as a large-size gantry crane, an elongated drive shaft 83 is necessary. In contrast, self-propelled robot 100 according to the present embodiment does not need drive shaft 83 that is expensive and has a large size, such as drive shaft 83 of a gantry crane and drive shaft 83 of a stage. In a conventional stationary device, the range of movement of drive shaft 83 is restricted. Work module 2 according to the present embodiment, which is driven by wheels, is free from restrictions on the range of movement of drive shaft 83 due to an upper limit of the dimensions of structure 200.

It should be understood that the embodiments disclosed herein have been presented for the purpose of illustration and non-restrictive in every respect. It is therefore intended that the scope of the present disclosure is defined by claims, not only by the embodiments described above, and encompasses all modifications and variations equivalent in meaning and scope to the claims.

### REFERENCE SIGNS LIST

1 mobile module; 2 work module; 7 frame portion; 11 controller; 21 work tool; 23 first sensor; 24 actuator; 28 second sensor; 29 tilt mechanism; 61 cable; 62 cable platform; 100 self-propelled robot; 200 structure; 300 floor.

1-13. (canceled)

14. A self-propelled robot for performing work on a structure, the self-propelled robot comprising:
a plurality of mobile modules each including a controller and configured to move relative to the structure; and
a work module configured to perform work on the structure and detachable from the plurality of mobile modules.

15. The self-propelled robot according to claim 14, wherein the work module is configured to perform work upward on the structure from below the structure or perform work downward on the structure from above the structure.

16. The self-propelled robot according to claim 14, wherein the controller is configured to control movement of each of the plurality of mobile modules and work of the work module based on a motion characteristic of the work module.

17. The self-propelled robot according to claim 16, comprising a plurality of the work modules, wherein
each of the plurality of work modules includes a work tool configured to perform work on the structure and is detachable from each of the plurality of mobile modules, and
a type of work by the work tool is different for each of the plurality of work modules.

18. The self-propelled robot according to claim 17, wherein the motion characteristic includes at least any of a size of the work module, a weight of the work module, a position of a center of gravity of the work module, a running resistance of each of the plurality of mobile modules, and a relative position of the work tool to each of the plurality of mobile modules.

19. The self-propelled robot according to claim 17, wherein
the work module further includes
an actuator configured to move the work tool along at least two directions crossing each other, and
a first sensor configured to recognize a position of the structure,
accuracy of movement of the work tool by the actuator is higher than accuracy of movement of each of the plurality of mobile modules, and
the actuator is configured to cause the work tool to approach the structure based on the position of the structure recognized by the first sensor.

20. The self-propelled robot according to claim 17, wherein
the work module further includes a second sensor,
the second sensor is configured to measure an angle of the structure with respect to the work tool, and
the controller is configured to control a direction of the work tool based on the angle measured by the second sensor.

21. The self-propelled robot according to claim 14, wherein the work module is configured to stand on its own.

22. The self-propelled robot according to claim 21, wherein the work module is detachable from each of the plurality of mobile modules while standing on its own.

23. The self-propelled robot according to claim 14, further comprising:
a cable connected to any of one of the plurality of mobile modules and the work module; and
a cable platform, wherein
the cable is configured to move according to movement of the plurality of mobile modules, and
the cable platform is configured to extend and contract according to movement of the plurality of mobile modules while supporting the cable.

24. A method of manufacturing a structure, the method comprising:
connecting a plurality of mobile modules of a self-propelled robot to a work module of the self-propelled robot; and
moving the plurality of mobile modules toward a structure and performing work on the structure by the work module,
wherein in the performing of work, a controller of each of the plurality of mobile modules controls movement of each of the plurality of mobile modules based on a motion characteristic of the work module and control work of the work module based on the motion characteristic of the work module.

25. The method of manufacturing a structure according to claim 24, wherein
a plurality of markers are arranged on a floor on which the plurality of mobile modules are self-propelled, and
the plurality of mobile modules move to a predetermined position, and then, are aligned with the structure relative to a marker closest to the self-propelled robot among the plurality of markers.

26. The method of manufacturing a structure according to claim 24, wherein
the plurality of mobile modules move on a frame portion covering the structure, and
the plurality of mobile modules perform work downward on the structure from above the frame portion.

27. The method of manufacturing a structure according to claim 24, wherein in the performing of work, the work module inspects the structure.
